(19) United States
(12) Patent Application Publication
(10) Pub. No.: US 2007/0017906 A1
(43) Pub. Date: Jan. 25, 2007

(54) Shimmed laser beam welding process for joining superalloys for gas turbine applications

(75) Inventors: Daniel Anthony Nowak, Greenville, SC (US); Ganjiang Feng, Greenville, SC (US); Lyle B. Spiegel, Niskayuna, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/169,695

(22) Filed: Jun. 30, 2005

(51) Int. Cl. B23K 26/20

(52) U.S. Cl. 219/121.64

(57) ABSTRACT

A method of laser beam welding at least two adjacent superalloy components includes (a) aligning the components along a pair of faying surfaces but without a backing plate; (b) placing a superalloy shim between the faying surfaces; (c) welding the components together using a laser beam causing portions of the superalloy components along the faying surfaces to mix with the superalloy shim; and cooling the components to yield a butt weld between the components.

### BACKGROUND OF THE INVENTION

This invention relates to gas turbine technology generally, and specifically, to a laser beam welding process for joining nickel, cobalt and iron-based superalloys.

Nickel-based superalloys like Rene N5, typically contain greater than 10% refractory elements and are generally viewed as unweldable. The use of a low heat input welding process, however, such as laser or electronic beam, has produced crack-free weld joints over a very narrow range of welding conditions. One drawback to these beam processes is the directional grain growth in the fusion zone which forms a distinct dendritic boundary in the center of the weld zone. This type of grain structure makes the joint vulnerable to centerline cracking and results in very poor fatigue strength. For example, the fatigue life of an electron beam welded N5/GTD-222 joint at 1200° F. and 0.9% strain fails at about 100 cycles, which is five times lower than that of lower strength GTD-222 base metal. Weld property levels in this range can result in catastrophic failure of the weld joint during operation of a gas turbine.

To overcome the centerline cracking problems, several alternative processes have been developed for welding superalloys. Among them, the wire feed electron beam process (wire feed EB), preplaced shim electron beam process (shim EB) and the gas tungsten arc process (TIG) have proven to be the best performers in improving fatigue life of the joint. The wire feed EB process adds ductile superalloy filler metal, through an automatic wire feeder during electron beam welding. Because of the increase ductility of the weld metal, the fatigue life of a wire feed EB joint improved to 1000 cycles at 1200° F. and 0.9% strain. However, this process is limited by the joint thickness. Also, lack of penetration (LOP) defects often occur when the joint thickness is increased beyond 0.1 inch. The sharp LOP defect can knock the fatigue life down to less than 10 cycles. The shim EB process greatly increased the joint thickness, however, an integral backer is required with the weld joint to stop the electron beam. This backer results in a stress riser at the root of the joint.

Another alternative process pursued was TIG welding with ductile superalloy filler metal. This multi-pass arc welding process completely changes the directional grain structure in the weld zone, introduces ductility into the weld metal, and eliminates the integral backer. As a result, the fatigue life of a TIG welded joint increased to 1300 cycles at 1200° F. and 0.9% strain. The high heat input associated with arc welding, however, can cause relatively large airfoil distortions and increase the risk of lack of fusion defects in the weld. Oftentimes, the amount of distortion prohibits the use of the TIG process as the primary welding process for complex airfoil structures.

### BRIEF DESCRIPTION OF THE INVENTION

The present invention provides a modified laser beam welding process to facilitate development of a defect-free superalloy weld joint which will improve low cycle fatigue life at high temperature and high strain range. The process is also designed to achieve a full penetration weld up to 0.5 inch deep, eliminate the need for an integral backer, reduce the propensity for lack of penetration defects, and decrease the risk for lack of fusion defects. The process also reduces part distortion and allows fit-up gap variations in the production joints of complex airfoil structures.

More specifically, and in one exemplary embodiment, a 0.010-0.040 inch thick nickel-based or cobalt-based shim is pre-placed and inserted between coupons of nickel-based, cobalt-based and iron-based superalloys (for example, GTD-222, GTD-111, A286, FSX-414 and Rene N5). The height of the shim extends about 0.010 inch-0.150 inch over that of the joint depth. In other words, the shim projects outwardly 0.010-0.150 inch above the joint surfaces. The base materials are welded to themselves and to each of the other candidate superalloys, without the use of a backer plate.

Accordingly, in one aspect, the invention relates to a method of laser beam welding at least two adjacent superalloy components comprising: (a) aligning the components along a pair of faying surfaces but without a backing plate; (b) placing a superalloy shim between the faying surfaces; (c) welding the components together using a laser beam causing portions of the superalloy components along the faying surfaces to mix with the superalloy shim; and cooling the components to yield a butt weld between the components.

In another aspect, the invention relates to method of laser beam welding at least two superalloy components comprising aligning the components along a pair of faying surfaces but without a backing plate; placing a superalloy shim between the faying surfaces; welding the components together using a laser beam causing portions of the superalloy components along the faying surfaces to mix with the superalloy shim; and cooling the components to yield a butt weld between the components; wherein the shim projects about 0.010 to 0.150° above the adjacent components; and wherein parameters for the laser welding include:
Wattage: 1000-3500
Speed: 8 to 30 ipm (inches per minute)
Focal Length: 7½ inches
Shim Thickness: 0.010 to 0.040 inch
Gap: 0 to 0.010 inch between shim and faying surfaces.

The invention will now be described in detail in connection with the drawings identified below.

### BRIEF DESCRIPTION OF THE DRAWINGS

FIG. 1 is a schematic diagram of a laser shim welding setup prior to welding; and

FIG. 2 is a schematic diagram of a finished laser shim weldment.

### DETAILED DESCRIPTION OF THE INVENTION

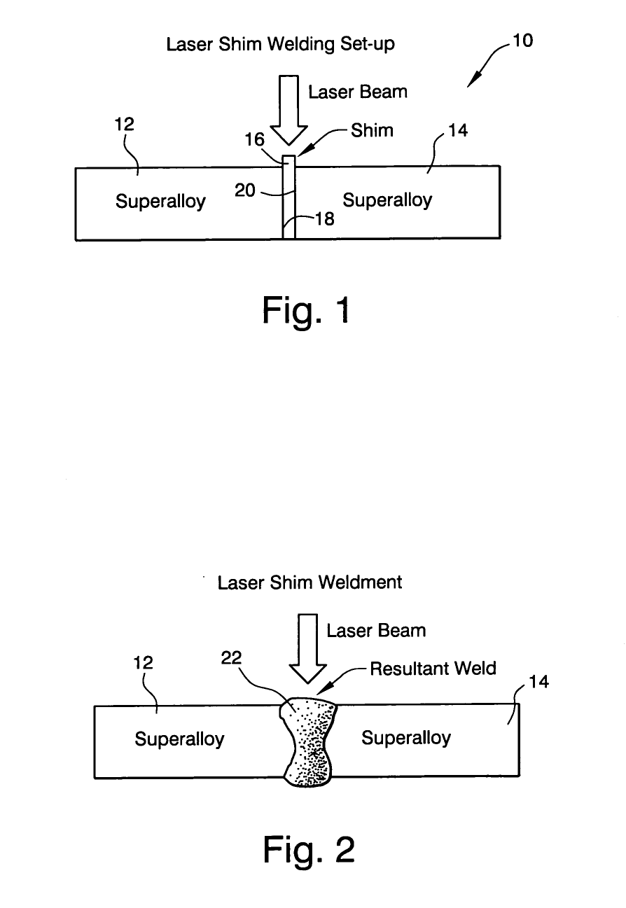

With reference to FIG. 1, a laser shim welding setup 10 includes a pair of coupons 12, 14 of a nickel-based superalloy (for example, GTD-222), with a shim 16 inserted between opposed faying surfaces 18, 20 located on either side of the nickel-based or cobalt-based shim 16. In the disclosed example, the shim 16 is between 0.010 and 0.040 inch thick, and note that the height of the shim extends about 0.10 to 0.150 inch over that of the joint depth, i.e., over the height or thickness of the coupons 12 and 14. The weld joint mock-ups are fit-up with weld joint gaps from 0 to 0.010 inch (between the shim 16 and faying surfaces 18, 20), and tack welded using a lower power setting with a laser beam. Spot tacks may be made every one half inch along the length of the joint.

In the disclosed example, the welding parameters used for the laser shim welding process may be as follows:
Wattage: 1000-3500
Speed: 8 to 30 ipm (inches per minute)
Focal Length: 7½ inches
Shim Thickness: 0.010 to 0.040 inch
Gap: 0 to 0.010 inch.
   Note that in laser beam welding, the beam itself moves along the weld joint whether it be planar or circular.

FIG. 2 illustrates the resultant butt weld 22, after cooling, bonding the superalloy coupons 12 and 14 together with the faying surfaces 18, 20 mixing with the material of the shim 16. Note that even without the backing plate, the weld material projects only slightly below the lower surfaces of the respective coupons 12, 14 and can be machined flush if desired. Similarly, the upper irregular surface of the weld may also be machined flush with the coupons.

It will be appreciated that the above-described laser shim welding process is also suitable for use with cobalt-based and iron-based superalloys, for example, GTD-111, A286, FSX-414, and Rene N5.

The modified laser beam welding process yields full penetration welds of up to 0.5 inch deep, eliminates the need for the integral backer plate, reduces the propensity for a lack of penetration defects, and decreases the risk for lack of fusion defects.

While described in terms of components or coupons, it will be appreciated that the welded components may be any of a variety of turbine parts, for example, steam exit chimneys to nozzle joints; bucket to bucket tip caps, etc.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of laser beam welding at least two adjacent superalloy components comprising:
(a) aligning the components along a pair of faying surfaces but without a backing plate;
(b) placing a superalloy shim between the faying surfaces;
(c) welding the components together using a laser beam causing portions of the superalloy components along the faying surfaces to mix with the superalloy shim; and cooling the components to yield a butt weld between the components.

2. The method of claim 1 wherein the superalloy components are nickel-based, cobalt-based or iron-based superalloys.

3. The method of claim 1 wherein said shim is a nickel-based or cobalt-based superalloy.

4. The method of claim 1 wherein the shim projects above the adjacent components.

5. The method of claim 4 wherein the shim projects about 0.010 to 0.150° above the adjacent components.

6. The method of claim 1 wherein the shim extends above the adjacent faying surfaces.

7. The method of claim 1 wherein the shim has a thickness of 0.010 to 0.040 inch.

8. The method of claim 1 wherein parameters for carrying out step (c) include:
Wattage: 1000-3500
Speed: 8 to 30 ipm
Focal Length: 7½ inches
Shim Thickness: 0.010 to 0.040 inch
Gap: 0 to 0.010 inch.

9. The method of claim 1 wherein the shim projects about 0.010 to 0.150° above the adjacent components.

10. A method of laser beam welding at least two superalloy components comprising:
aligning the components along a pair of faying surfaces but without a backing plate;
placing a superalloy shim between the faying surfaces;
welding the components together using a laser beam causing portions of the superalloy components along the faying surfaces to mix with the superalloy shim; and cooling the components to yield a butt weld between the components;
wherein the shim projects about 0.010 to 0.150° above the adjacent components; and wherein parameters for the laser welding include:
Wattage: 1000-3500
Speed: 8 to 30 ipm
Focal Length: 7½ inches
Shim Thickness: 0.010 to 0.040 inch
Gap: 0 to 0.010 inch.
